(19) United States
(12) Patent Application Publication
(10) Pub. No.: US 2007/0279353 A1
(43) Pub. Date: Dec. 6, 2007

(54) ACTIVE MATRIX SUBSTRATE, REFLECTION TYPE OF LIQUID CRYSTAL DISPLAY AND PROJECTION TYPE LIQUID CRYSTAL DISPLAY APPARATUS

(75) Inventor: Masanobu Oomura, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/747,044

(22) Filed: May 10, 2007

(30) Foreign Application Priority Data
May 30, 2006 (JP) 2006-149893

(51) Int. Cl. G09G 3/36

(52) U.S. Cl. 345/87

(57) ABSTRACT

An object of the present invention is to reduce the number of necessary terminals on a substrate, realize data transmission resistant to disturbance noise even when a source voltage of a logic system for processing a digital video signal is lowered, reduce an influence of a radiated noise, and provide an output image of high picture quality. For that purpose, a reflection type of liquid crystal display has a silicon substrate 1 as an active matrix substrate, uses the digital video signal for a video signal to be input, and converts the digital video signal into an analog video signal in the silicon substrate 1 to provide the output image. The reflection type of liquid crystal display having the above configuration has a DAC circuit 22 for converting the input digital video signal into the analog video signal; and an LVDS receiver 20 which receives each digital video signal that is to be input into the DAC circuit 22, through a LVDS transmission. The LVDS receiver 20 is mounted on the same silicon substrate 1 as the DAC circuit 22 is mounted.

### BACKGROUND OF THE INVENTION

1. Field of the Invention

The present invention relates to an active matrix substrate, a reflection type of liquid crystal display and a projection type liquid crystal display apparatus, and particularly relates to the reflection type of liquid crystal display having the active matrix substrate formed with the use of a single-crystal semiconductor substrate.

2. Description of the Related Art

In recent years, a liquid crystal display has been widely used for a small display device and a terminal of so-called office automation equipment, and particularly a projection type liquid crystal display apparatus for projecting an image on a large screen has been popularly used in the field of the office automation equipment.

This type of projection type liquid crystal display apparatus is generally classified into a light transmitting type of a liquid crystal and a reflection type of liquid crystal display. The light transmitting type of the liquid crystal has a problem that a switching element (transistor), a capacitor and an electric wire installed in each pixel decrease an aperture ratio of a transmissive region for making light pass therethrough in the pixel. In contrast to this, the reflection type of liquid crystal display can prepare a reflective electrode in a region except a part for insulatingly isolating the pixel electrode for reflection (hereafter referred to as “reflective electrode”), in each pixel; and can arrange the switching element, the capacitor and the electric wire necessary for driving an active matrix, in a lower part of the reflective electrode. For this reason, the reflection type of liquid crystal display has more advantages than the light transmitting type of the liquid crystal, when miniaturizing a liquid-crystal display panel, increasing the definition and increasing the brightness.

In general, the above described reflection type of liquid crystal display has: a plurality of reflective electrodes connected to a switching element such as an MOS (metal-oxide-semiconductor) transistor configured in a matrix form on a semiconductor substrate (Si substrate); a transparent common electrode common to all the pixels configured so as to face a plurality of the reflective electrodes; and further a liquid crystal filled in between the reflective electrode of the semiconductor substrate and the common electrode. Thus configured reflection type of liquid crystal display makes light incident on the reflective electrode from a common electrode side, and modulates the reflected light by making a potential difference between the common electrode and the reflective electrode correspond to a picture signal and controlling an orientation of the liquid crystal in each pixel.

In recent years, a liquid crystal display has been required to have higher definition, and a reflection type of liquid crystal display is strongly required to have a high-definition pixel because of projecting an image on a large screen. Accordingly, when the high-definition reflection type of liquid crystal display is produced according to an easy way of thinking, a size of a chip on a semiconductor substrate will be steadily enlarged. However, the enlargement directly causes the increase of a cost. Accordingly, the chip size is desirably minimized, and thus the pixel is required to be refined.

In general, a voltage to be applied to the liquid crystal of the liquid crystal display is inverted, for instance, in each frame, so as to reliably protect the liquid crystal from ghosting and the like. The operation of inversely applying the voltage is so-called inversion driving. Accordingly, a video signal needs to make an amplitude of the voltage 10 V or larger, and furthermore, source voltage necessary for driving the liquid crystal display is required to be about 15 V (or higher).

### SUMMARY OF THE INVENTION

However, the above described conventional technology had problems described below.

In general, a liquid crystal display writes information onto a pixel at a very high rate, so that a video signal inevitably becomes a high-frequency analog signal. Accordingly, a transfer switch is required to finish transfer at a high speed, and needs to be larger in size due to the higher-speed transfer. In addition, the liquid crystal display needs wiring for connecting a common signal wire with a pad which connects a common signal wire with an external circuit, and as a result, the common signal wire causes very large capacitance. Furthermore, the liquid crystal display uses a video signal with an amplitude as large as 10 V or larger, as described above. As described above, the liquid crystal display needs to drive a large capacitive load at a high speed with a large amplitude, needs to employ an external driving circuit having extremely high performance, and consequently causes a problem of consuming a larger amount of an electric power.

Besides, when the liquid crystal display uses a flexible cable for connecting a common signal wire to an external circuit, the ringing of a signal increases along with the increase of load capacitance, because a reactance component increases in proportion to the length of the cable. Thus, the liquid crystal display had also a problem that the length of the cable was limited and a degree of flexibility in design for devices was decreased.

On the other hand, when the number of display pixels increases, a driving speed of a signal wire connected to a transistor of a substrate equipped with an active-matrix driving circuit becomes smaller. Japanese Patent Application Laid-Open No. H02-216190 discloses a method for solving the problem. The Japanese Patent Application Laid-Open No. H02-216190 uses a driving circuit for a signal wire, which uses a signal including a plurality of bits with gradated information as an input signal, and has a digital to analog converter (DAC) that includes at least a capacitor and a switch, and temporally serially inputs the signal with a plurality of bits.

The above driving circuit for a signal wire is input with a digital signal, and accordingly employs DAC (Digital to Analog Converter). The display device using the DAC including the capacitor and the switch converts a temporally serially input digital bit data to an analog data, and accordingly is considered to be capable of highly precisely converting the digital data to the analog data in a small size of a circuit. However, it is not practical to prepare a corresponding number of DAC circuits to the number of signal wires in a peripheral part of a display region, for the purpose of inputting a video signal into a signal wire in a liquid crystal panel with a large number of effective display pixels.

A conventional technology adapted in consideration of the above described problem is disclosed in Japanese Patent Application Laid-Open No. H10-177371. The Japanese Patent Application Laid-Open No. H10-177371 discloses a liquid crystal display having a horizontal scanning circuit, a latch circuit, a DAC, a plurality of signal transfer switches and a selective circuit. The horizontal scanning circuit samples a video data based on a digital video signal. The latch circuit stores the data in synchronization with the output sent from the horizontal scanning circuit. The DAC converts the output sent from the latch circuit into an analog signal. A plurality of the signal transfer switches are arranged in between DAC and a plurality of the signal wires. The selective circuit selects at least one switch from among a plurality of the signal transfer switches.

The above liquid crystal device can reduce the number of components of an external driving circuit, and can make a load on a video signal wire lower by inputting a digital data than the liquid crystal display of inputting an analog data and directly driving a liquid crystal element. Furthermore, the liquid crystal device can also reduce a load per one DAC, can increase a writing period of time into a liquid crystal pixel, and can consequently decrease a driving frequency. Thereby, the liquid crystal device can easily decrease power consumption as a whole, can lessen the influence of noise, and can provide high picture quality.

The liquid crystal device equipped with a DAC has advantages as described above, but a liquid crystal display equipped with a DAC has problems which will be now described below.

(1) When the number of simultaneously input data of (n) bit into DAC is defined as a channel number (ch), the number of video signal terminals required on a panel, namely, a PAD number is a product of (n) bit×(m) channel. For instance, when being equipped with 8 channels of DAC circuits having a resolution power of 12 bit, the liquid crystal display needs to prepare 96 terminals, which are unpractical.

(2) As a countermeasure of it, there is a method of inputting data into the DAC in a serial input way in place of a parallel input way. Then, the number of terminals (the number of PAD) is reduced, but a high rate of data transmission becomes necessary. Accordingly, a countermeasure against the noise which disturbs a signal in a transmission path has to be considered. The countermeasure against the noise is further necessary when considering that a source voltage of an integrated circuit in a digital processing system side is lowered from 5 V to 3 V and from 3 V to 2.5 V in recent years. Furthermore, radiated noise must be also taken into account.

An object of the present invention is to reduce the number of necessary terminals on a substrate, realize data transmission resistant to disturbance noise even when a source voltage of a logic system for processing a digital video signal is lowered, reduce an influence of the radiated noise, and provide an output image of high picture quality.

In order to achieve the above described object, the present invention provides an active matrix substrate formed from a semiconductor substrate for converting, as a digital video signal, a video signal to be inputted, and for converting the digital video signal into an analog video signal in the semiconductor substrate to provide an output image, comprising: a digital-to-analog conversion circuit for converting the input digital video signal into the analog video signal; and a receiving circuit for receiving through differential transmission each digital video signal inputted into the digital-to-analog conversion circuit, wherein the receiving circuit is mounted on the same semiconductor substrate together with the digital-to-analog conversion circuit is mounted.

In the present invention, the differential transmission can be a low voltage differential signaling transmission and the receiving circuit can be a low voltage differential signaling receiver. The low voltage differential signaling receiver may have a low voltage differential signaling receiver circuit which receives each digital video signal to be input into a plurality of the digital-to-analog conversion circuits, as one serial signal. Alternatively, the low voltage differential signaling receiver may have a plurality of low voltage differential signaling receiver circuits which are arranged so as to respectively pair up with a plurality of the digital-to-analog conversion circuits, and individually receive each digital video signal to be input into each of the digital-to-analog conversion circuits, as respective serial signals. Further alternatively, the low voltage differential signaling receiver may have a plurality of the low voltage differential signaling receiver circuits which individually receive each digital video signal to be input into a plurality of the above described digital-to-analog conversion circuits, as a plurality of serial signals allocated to each bit of the digital-to-analog conversion circuits.

A reflection type of liquid crystal display according to the present invention includes: the active matrix substrate according to any one of the above descriptions; an opposite substrate arranged so as to face the active matrix substrate; and a vertical alignment type liquid crystal layer sandwiched between the active matrix substrate and the opposite substrate.

The reflection type of liquid crystal display according to the present invention may further have: an external circuit substrate electrically connected to the active matrix substrate; and a transmission circuit which pairs up with the receiving circuit, wherein the transmission circuit may be mounted on the external circuit substrate. The transmission circuit may be a low voltage differential signaling driver.

A projection type liquid crystal display apparatus according to the present invention includes using a reflection type of liquid crystal display according to any one of the above descriptions.

A reflection type of liquid crystal display and a projection type liquid crystal display apparatus according to the present invention can provide an output image of high picture quality, by reducing the number of necessary terminals on a substrate, realizing a data transmission resistant to disturbance noise even when a source voltage of a logic system for processing a digital video signal is lowered, and reducing an influence of radiated noise.

Further features of the present invention will become apparent from the following description of exemplary embodiments with reference to the attached drawings.

### BRIEF DESCRIPTION OF THE DRAWINGS

FIG. 1 is a perspective view illustrating a total structure of a reflection type of liquid crystal display according to a first exemplary embodiment of the present invention.

FIG. 2 is a plan view illustrating a configuration of a pixel region and a driving circuit mounted on a silicon substrate in a first exemplary embodiment of the present invention.

FIG. 3 is a circuit diagram illustrating an internal configuration of a pixel unit in a first exemplary embodiment of the present invention.

FIG. 4 is a block diagram illustrating a whole configuration of a reflection type of liquid crystal display according to a first exemplary embodiment of the present invention.

FIG. 5 is a circuit diagram illustrating an internal configuration of a pixel region and a driving circuit mounted on a silicon substrate in a first exemplary embodiment of the present invention.

FIG. 6A is a circuit diagram illustrating a configuration for an input/output circuit of an LVDS driver and an LVDS receiver, and FIG. 6B is a diagrammatic drawing illustrating an input/output signal level in the input/output circuit.

FIG. 7 is a timing chart illustrating a behavior of a reflection type of liquid crystal display according to a first exemplary embodiment of the present invention.

FIG. 8 is a view illustrating an example of a logic signal in which noise is superimposed.

FIG. 9 is a circuit diagram illustrating an internal configuration of a pixel region and a driving circuit arranged on a silicon substrate in a reflection type of liquid crystal display according to a second exemplary embodiment of the present invention.

FIG. 10 is a timing chart illustrating a behavior of a reflection type of liquid crystal display according to a second exemplary embodiment of the present invention.

FIG. 11 is a circuit diagram illustrating an internal configuration of a pixel region and a driving circuit arranged on a silicon substrate in a reflection type of liquid crystal display according to a third exemplary embodiment of the present invention.

FIG. 12 is a circuit diagram illustrating an internal configuration of a pixel region and a driving circuit arranged on a silicon substrate in a reflection type of liquid crystal display according to a fourth exemplary embodiment of the present invention.

FIG. 13 is a timing chart illustrating a behavior of a reflection type of liquid crystal display according to a fourth exemplary embodiment of the present invention.

FIG. 14 is a view illustrating a whole configuration of a liquid-crystal projector using a reflection type of liquid crystal display according to the present invention.

FIG. 15 is a view illustrating a configuration of a liquid crystal projector using a liquid-crystal projector shown in FIG. 14.

### DESCRIPTION OF THE EMBODIMENTS

In the next place, the best mode for carrying out an active matrix substrate, a reflection type of liquid crystal display and a projection type liquid crystal display apparatus according to the present invention will be described in detail with reference to the drawings.

### Exemplary Embodiment 1

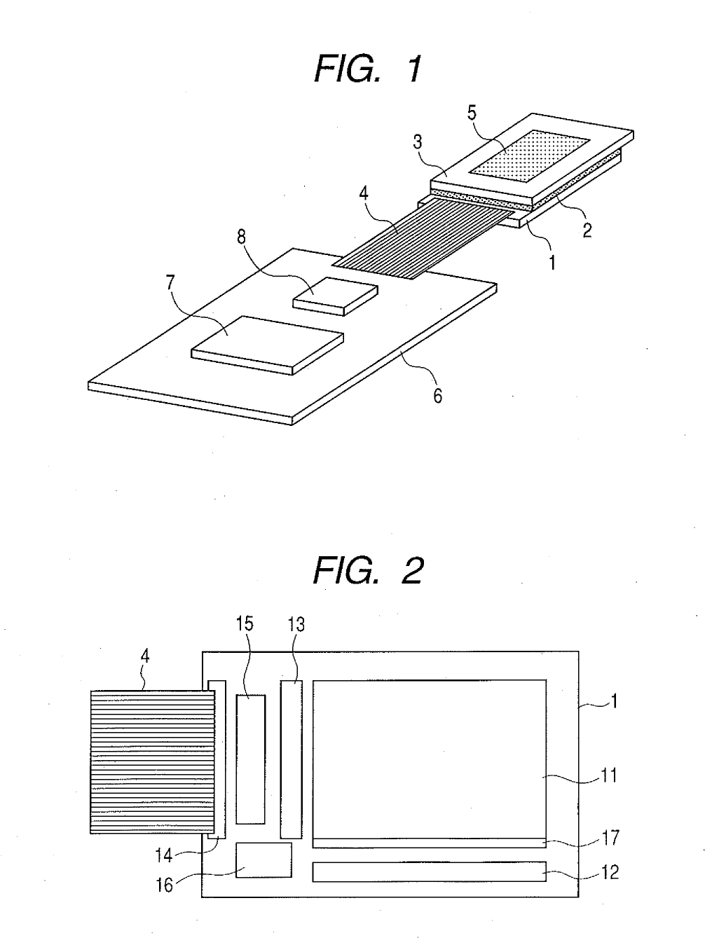

At first, a first exemplary embodiment according to the present invention will be described with reference to FIG. 1 to FIG. 8.

FIG. 1 diagrammatically illustrates an example of a system of a reflection type of liquid crystal display (display panel) according to the present exemplary embodiment.

In FIG. 1, reference numeral 1 denotes a silicon substrate (single-crystal semiconductor substrate) which is a substrate for a liquid crystal display (active matrix substrate) integrally formed of a driving circuit and a pixel unit (which will be described later). Reference numeral 3 denotes a transparent electrode (opposite substrate) which works as a common electrode when a liquid crystal inversely driven. Reference numeral 5 denotes a display region. A sealant 2 is arranged in between the silicon substrate 1 and the transparent electrode 3 so as to surround the display region 5. A liquid crystal layer is filled in the space surrounded by the silicon substrate 1, the sealant 2 and the transparent electrode 3. A vertical alignment type of a liquid crystal material formed of molecules with a negative dielectric anisotropy is used for a material of liquid crystal layer, in the present exemplary embodiment. Furthermore, the PAD of a power source and each signal are collected in one side of four sides of the silicon substrate 1. Flexible wiring 4 is connected to the PAD. The power source and each signal are input thorough the one flexible wiring 4. All the signals and the power sources are collected in the one side of the silicon substrate 1 in consideration of the convenience of mounting and a cost.

Reference numeral 6 denotes a drive substrate (external driving circuit board) equipped with IC (integrated circuit) for controlling a display panel and outputting video data. Reference numeral 7 denotes the control IC for receiving data from an image source (not illustrated) and outputting a timing relationship such as a clock and the video data. Reference numeral 8 denotes a transmission circuit (hereafter referred to as LVDS driver IC) which converts the video data output from the control IC 7 into a LVDS (Low Voltage Differential Signaling) signal that is a digital signal, and outputs the data to a display panel through the flexible wiring 4.

A driving circuit such as a scanning circuit and a pixel electrode are formed on the same silicon substrate 1, and all of them form a reflection type of liquid crystal display of driving-circuit-integrated type. As described above, the reflection type of liquid crystal display using a single-crystal semiconductor substrate as an element substrate is referred to as LCOS (Liquid Crystal On Silicon).

FIG. 2 is an example illustrating the configuration of a pixel region and a driving circuit on a silicon substrate 1 in the reflection type of liquid crystal display of driving-circuit-integrated type.

In FIG. 2, reference numeral 11 denotes a pixel region (pixel unit), reference numeral 12 denotes a horizontal scanning circuit, reference numeral 13 denotes a vertical scanning circuit, reference numeral 14 denotes a PAD section, reference numeral 15 denotes an I/O (Input/Output) section, reference numeral 16 denotes a DAC section and reference numeral 17 denotes a transfer switch group. These respective elements 11 to 17 are integrally formed on the same silicon substrate 1. Reference numeral 4 denotes the flexible wiring shown in FIG. 1 and is connected to the PAD section 14. All of the power sources, control signals and video data signals are supplied from the flexible wiring 4 connected to one side of a silicon substrate 1. A later described receiving circuit (hereafter referred to as LVDS receiver circuit) for a digital signal and the data control circuit are arranged on the I/O section 15.

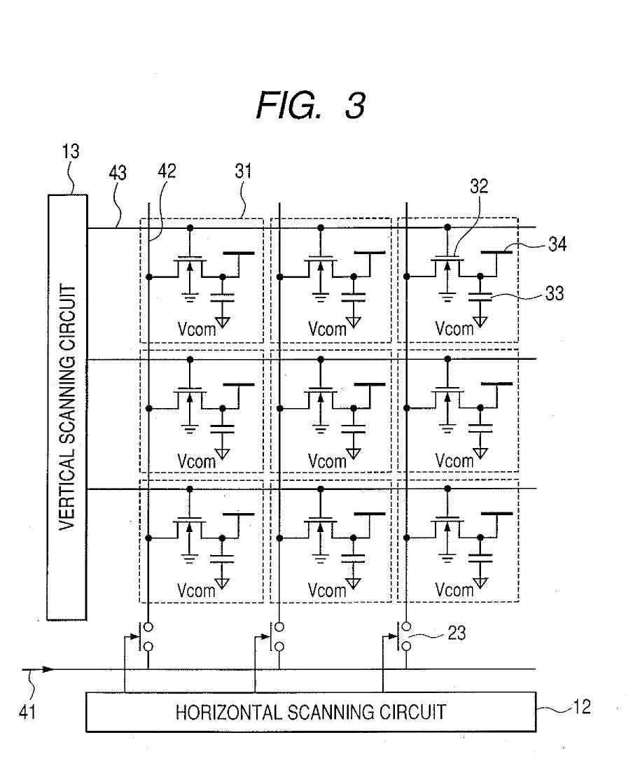

FIG. 3 illustrates a circuit configuration of a pixel unit 11 formed on a silicon substrate 1. FIG. 3 illustrates the circuit used in an active-matrix driving circuit of a general reflection type of liquid crystal display. FIG. 3 illustrates a configuration of the pixel unit 11 arranged into a matrix form of 3 lines by 3 rows (3 by 3) as a matter of convenience, but the present invention is not limited to the configuration.

In the example of FIG. 3, the pixel unit 11 is formed on a P-type Si substrate which is the silicon substrate 1. In FIG. 3, reference numeral 31 denotes one pixel. The pixel 31 includes a switching element 32 made of a switching transistor and the like, a storage capacitor 33 and a reflective electrode 34. The switching element 32 in the pixel 31 is formed of a NMOS transistor. Gates of the switching elements 32 in the pixels 31 existing on the same row is connected to a gate wire 43, and the output of each register a vertical scanning circuit (vertical shift register) 13 is applied to the gate wire 43. Sources (in left side of illustrated NMOS transistor) of the switching elements 32 in the pixels 31 on the same column are connected to a signal wire 42. A drain (in right side of illustrated NMOS transistor) of the switching element 32 of each pixel 31 is connected to the storage capacitor 33 and the reflective electrode 34. The storage capacitor 33 has the other end connected to a Vcom potential which is common to all the pixels. The signal wire 42 is connected to a video wire 41 through a transfer switch 23. A horizontal scanning circuit (horizontal shift register) 12 controls ON/OFF of the transfer electric switch 23 by output from each register.

An operation of a circuit for a pixel unit 11 illustrated in FIG. 3 will be now simply described. At first, a video signal sequentially input with staggered timing is output to a video wire 41. A horizontal scanning shift register 12 supplies video signal voltage to the signal wire 42, which has been sampled by sequentially turning a transfer switch 23 into an ON state (conduction state). A switching element 32 of a desired pixel 31 in the position is selected and converted into the ON state, at which one signal wire 42 intersects with a gate wire 43 selected by a vertical scanning shift register 13. Then, the video signal voltage is written in a storage capacitor 33 through the switching element 32. A reflective electrode 34 acquires the voltage written in the storage capacitor 33. Then, a potential difference generated by the reflective electrode 34 and a transparent common electrode (not illustrated) is applied to a liquid crystal and changes optical properties of the liquid crystal.

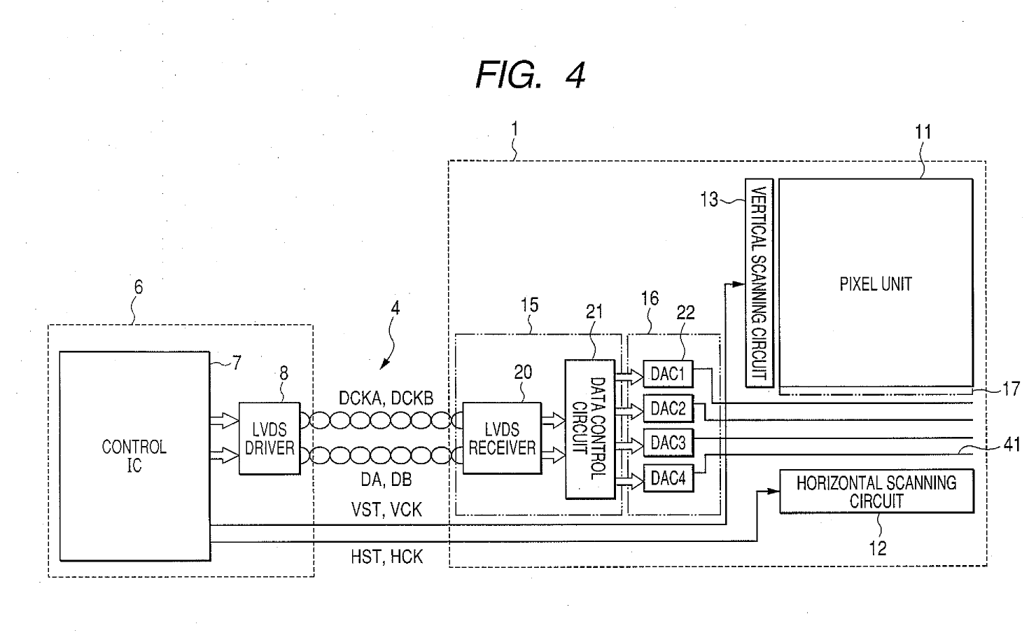

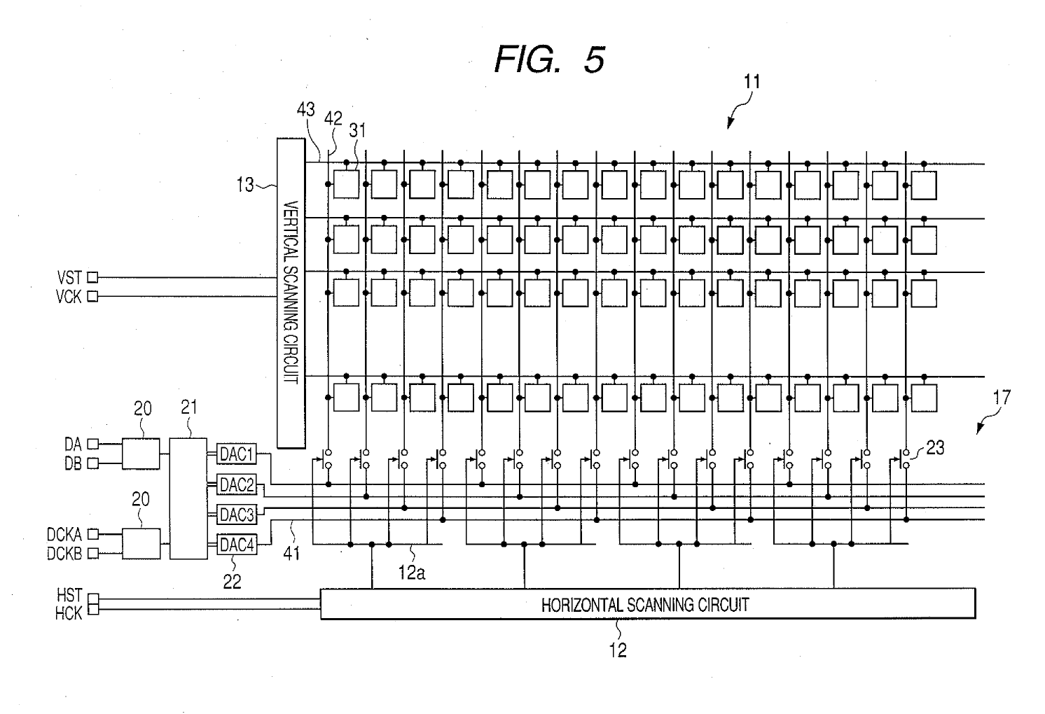

FIG. 4 is a diagrammatic circuit block diagram illustrating an example of a reflection type of liquid crystal display. FIG. 5 illustrates a circuit configuration of a pixel region and a driving circuit integrally formed on a silicon substrate 1.

FIG. 4 and FIG. 5 illustrate an example of a liquid crystal display, which uses four video wires 41 for simultaneously writing video voltage on every four pixels for a driving circuit of a pixel region, so as to secure a period of time for writing the video voltage into each pixel 31. The video wires 41 are respectively connected to a plurality of DAC circuits 22 (DAC1 to DAC4) for forming respective analog video signals from input digital video signals. The number of being simultaneously written into the pixel 31 shall be referred to as a channel number (ch). Each DAC 22 is arranged in a DAC section 16 in the above described FIG. 2.

Reference numeral 20 denotes an LVDS receiver circuit, and there arranged are two circuits for a video signal and a video signal clock. The LVDS receiver circuit 20 can be mounted on a PAD region for a driving circuit on a silicon substrate 1 or its peripheral area, and is arranged in an I/O section 15 adjacent to PAD 14 in the above described FIG. 2, in the present exemplary embodiment. Reference numeral 21 denotes a data control circuit, and mainly includes a shift register and a latch circuit. The data control circuit 21 is connected to and is sandwiched between two LVDS receiver circuits 20 and four DAC circuits 22, and is arranged in the I/O section 15.

Reference characters HCK and HST in the figure respectively denote a horizontal timing clock signal and a horizontal timing start signal which are supplied from a control IC of an external driving circuit board. Terminals for receiving these respective signals are arranged in a PAD section 14 in the above described FIG. 2. The horizontal timing start signal HST and the horizontal timing clock signal HCK are input into a horizontal scanning circuit 12. An output of the horizontal scanning circuit 12 is connected to a gate of each transfer electric switch 23 in the group of transfer electric switches 17, through a switch (SW) control wire 12a. The horizontal scanning circuit 12 outputs a control signal to the SW control wire 12a, which can simultaneously turn on and off four transfer switches 23 that are connected to the signal wire 42 for four pixels.

Reference characters VCK and VST in the figure respectively denote a vertical timing clock signal and a vertical timing start signal which are supplied from a control IC of an external driving circuit board. Each terminal for receiving each of these signals is arranged in a PAD section 14 in the above described FIG. 2. The vertical timing clock signal VCK and the vertical timing start signal VST are input into a vertical scanning circuit 13. An output of the vertical scanning circuit 13 is connected to a gate of a switching element (NMOS) of each pixel 31.

Reference characters DA and DB in the figure denote a pair of digital video signals to be LVDS transmitted to an LVDS receiver through an LVDS driver IC of an external driving circuit board. In addition, reference characters DCKA and DCKB in the figure denote a pair of video signal clocks to be LVDS transmitted to the LVDS receiver through the LVDS driver IC of the external driving circuit board. Each terminal to receiving these digital video signal and video signal clock is arranged in the above described PAD section 14 in FIG. 2.

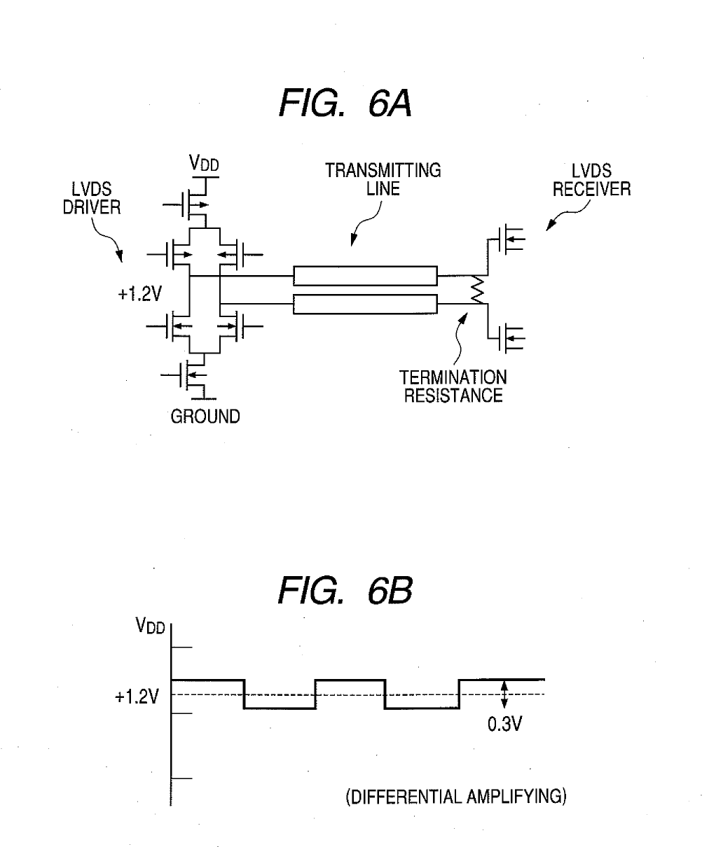

FIGS. 6A and 6B illustrate respective examples for a configuration of an input/output circuit of the above described LVDS driver IC 8 and LVDS receiver circuit 20, and for an input/output signal level.

LVDS is an abbreviation of a low voltage differential signaling (low amplitude differential signal transmission method) which is standardized as a TIA/EIA Standard 644 in TIA/EIA (Telecommunication Industries Association/Electronic Industries Alliance). The LVDS method is a differential signaling method of sending a pair of signals having mutually reverse current/voltage amplitudes (pair of differential signals of which the phases are mutually reversed) to an LVDS receiver from an LVDS driver, with the use of two signal wires (transmitting lines).

FIG. 6A illustrates an example of an internal configuration of a generally known LVDS driver and LVDS receiver. In the example, the LVDS driver generates a pair of differential signals of which the phases are reversed, and the LVDS receiver detects a difference between the pair of differential signals through a termination resistance between two transmitting lines. As for an internal configuration of a transistor network composing the driver and the receiver, a well-known configuration can be employed, so that the description will be omitted.

The differential signaling method has an advantage of being capable of eliminating noises when the noises have equally appeared in two signal lines and two signal lines are overlapped, because the receiver detects only the difference between a pair of the signals. In other words, the receiver using the differential signaling method detects only the potential difference between the two signals even when the noises of the same phase are added to the signals, and accordingly can eliminate the influence of the noise. In addition, the differential signaling has properties of emitting less noise than the single end signal which sends data through one signal wire, because the differential signals mutually cancel the magnetic fields. In addition, the method transmits respective signals having phases different by 180 degrees to the two signal wires, and detects only the difference; and accordingly has also an advantage of consuming a less electric power than the HVD (High Voltage Differential) method, because the differential signaling can transmit even the signal of low voltage (e.g. voltage of +1.2V) and a low amplitude (e.g. amplitude of 0.3 V), as shown in FIG. 6B.

Incidentally, a liquid crystal display using a poly-silicon TFT formed on a glass substrate cannot be operated at a high speed because the transistor has low characteristics, particularly low current-driving performance, but the crystalline silicon substrate 1 as in the present exemplary embodiment can mount an LVDS receiver circuit 20 thereon, because the transistor formed on the crystalline silicon substrate 1 shows superior current driving performance.

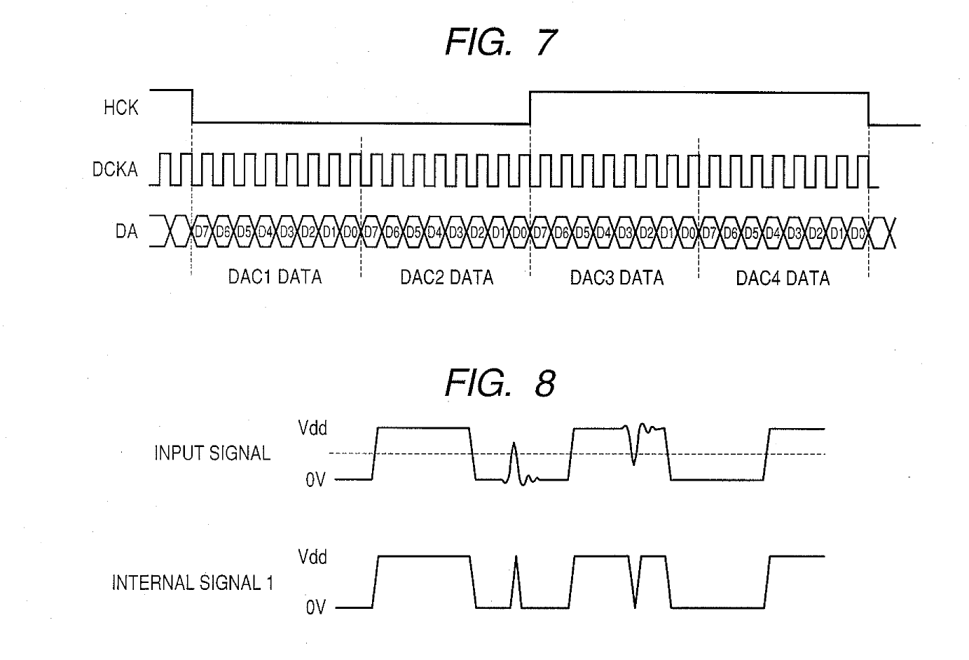

In the next place, an operation of the present exemplary embodiment will be described with reference to FIG. 7.

FIG. 7 illustrates an example of a timing chart showing a relationship among a video signal DA, a video signal clock DCKA and a horizontal timing clock signal HCK, in a configuration shown in the present exemplary embodiment. In the above example, the video signals DA to be input into four DAC circuits 22 are shown in 8 bit (D0 to D7) respectively. Reference characters DB and DCKB are not illustrated, but the DB is a reverse signal of the DA and the DCKB is the reverse signal of the DCKA. As for other control signals (HST, VCK and VST) to be input into the scanning circuit, a well-known technology can be applied to all of the circuits. The other control signals do not directly relate to characteristic parts of the present invention, so that the description will be omitted.

At first, a video signal DA is received by an LVDS receiver circuit 20. The video signal DA is a serial data, and accordingly is converted to parallel data formed of four units (data of DAC1 to DAC4) with every 8 bit so as to synchronize with a video signal clock DCKA, by a shift register (not shown) in a data control circuit 21. Subsequently, each parallel data is latched in a latch circuit (not shown) of the data control circuit 21, on desired timing. In the above described FIG. 5, the description about the latch signal is not illustrated. However, the latch signal may be supplied from the outside of a liquid crystal display similarly to the case of the video signal clock. The latch timing may be generated from the video signal clock, in the data control circuit 21.

Digital video signals of 8 bit which have been converted into parallel data and latched in a data control circuit 21 are output into four corresponding DAC circuits 22 in parallel respectively, and are converted into analog video signals in the respective DAC circuits 22. The converted analog video signals are output to respective video wires 41.

On the other hand, concurrently with the above operation, a horizontal timing clock signal HCK is input into a horizontal scanning circuit 12. The horizontal timing clock signal HCK includes such clock signals as serial data for 4 channels, namely, 32 bits (8 bits multiplied by 4 channels) of a video signal clock DCKA correspond to one period. Accordingly, each analog video signal in four video wires 41 is simultaneously sent to corresponding four signal wires 42, when each transfer switch 23 is turned on by output from a horizontal scanning circuit 12 based on the HCK. Thereby, in a pixel unit 11, the respective analog video signals are simultaneously written in the corresponding four pixels 31 through each signal wire 42. Afterwards, the circuit in the pixel unit 11 operates in the same way as described above.

Accordingly, a liquid crystal display according to the present exemplary embodiment has a DAC circuit 22 for generating a video signal and an LVDS receiver circuit 20 mounted on the same silicon substrate 1, and accordingly possesses such advantages as described in the following items (1) to (5).

(1) A data transfer rate is increasing along with the widening of a display area (resolution) in recent years. When the data is transferred through flexible wiring 4, the data transfer rate is limited, because a waveform of a single-phase full swing signal (CMOS level signal) is smoothed by parasitic elements (L, C and R) of the flexible wiring 4. When implementing a display panel, it is unavoidable to use the flexible wiring 4 for a power source and a signal transmission route.

In contrast to this, a liquid crystal display in the present exemplary embodiment transmits a video signal in a LVDS mode, and accordingly can precisely transmit the video signal at a high speed even through the flexible wiring 4.

(2) Consider a display panel which is not equipped with a DAC circuit 22 on the same silicon substrate 1, namely, which receives an analog video signal that sharply fluctuates in a range of 1 to 11 V. Alternatively, consider a display panel which has the DAC circuit 22 mounted on the same silicon substrate 1 and receives extremely many digital video signals that sharply change in between 0 to 3 V at a high speed. In these display panels, noise originating in fluctuating picture signals overlaps with logic signals (HST, HCK, VST and VCK), causes a malfunction of the liquid crystal panel, and can be a factor of remarkably deteriorating picture quality. The noise originating in the picture signal more seriously affects the picture quality, as the voltage of a logic signal is lowered. The factors of overlapping the noise on the logic signals are considered to be coupling capacitance occurring between a picture signal wire and a control signal wire on flexible wiring 4, and coupling capacitance occurring between wiring for a logic system power source and wiring for a picture signal, in an input section on a silicon substrate 1.

An input section of a conventional driving circuit receives signals with a logic gate such as an inverter, and simultaneously forms a waveform of noise as well as an original signal when having received a control signal on which the noise is superimposed, so that the driving circuit operates on the basis of the control signal having chattering.

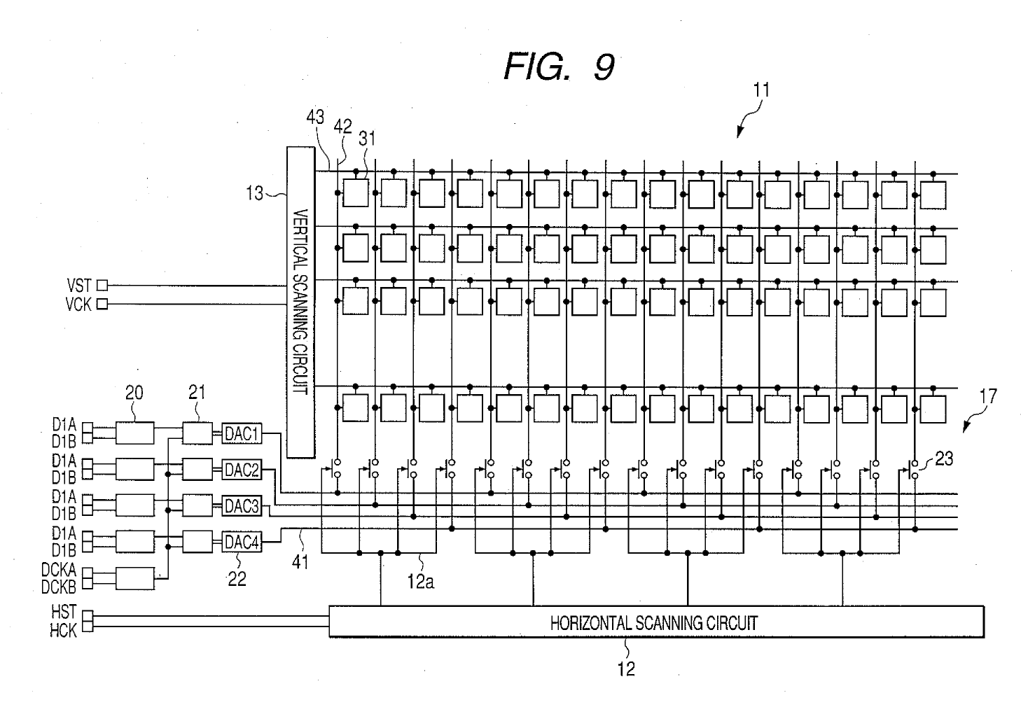

FIG. 8 illustrates an example of a logic signal on which noise is superimposed. The above example of an input signal shows a waveform when the noise exceeding a voltage of a threshold level of a logic circuit (for instance, voltage of Vdd/2) is superimposed on the control signal. In the case, the logic circuit in a liquid crystal panel forms a waveform as shown in an internal signal 1 of FIG. 8, and transmits the noise content to a driving circuit section in a silicon substrate 1, as if the noise is one part of a regular signal. For instance, when the noise is added to an HCK signal, a transfer switch is wrongly turned on, and consequently a picture signal for a different pixel is sampled. In addition, when the noise is added to an HST signal, a plurality of the transfer switches are simultaneously turned on. Furthermore, when the noise is added to a VCK signal, voltage is written in a pixel of a next row on the way of horizontal scanning. All of the above operations cause the remarkable deterioration of picture quality.

In contrast to this, in the present exemplary embodiment, noise is not superimposed on control signals (HST, HCK, VST and VCK) to be input into a horizontal scanning circuit 12 and a vertical scanning circuit 13, because video signals are transmitted to the scanning circuits in an LVDS mode. As a result of this, the present exemplary embodiment can stably operate the horizontal scanning circuit 12 and the vertical scanning circuit 13.

(3) The radiated noise generated from flexible wiring 4 can be reduced in the present exemplary embodiment, because an LVDS transmission method is employed.

(4) The liquid crystal display in the present exemplary embodiment can reduce a cost of a display system as a whole, because of mounting the DAC circuit 22 for generating the video signal and the LVDS receiver circuit 20 on the same silicon substrate 1.

(5) It is generally difficult for a display panel using a poly-silicon TFT (Thin Film Transistor) to prepare a circuit corresponding to low source voltage (2.5 V) thereon, because the poly-silicon TFT has a high voltage of a threshold level (Vth=1 to 1.5 V). In contrast to this, the liquid crystal display in the present exemplary embodiment can cope with lowered source voltage (from 5 V to 3 V or from 3 V to 2.5 V) for the system, because of employing the above described LVDS transmission.

As described above, a reflection type of liquid crystal display according to the present exemplary embodiment has a plurality of DAC circuits 22 mounted on a silicon substrate 1 of the liquid crystal display, inputs a video data in a form of a digital signal, and converts the digital video signal into an analog video signal in the silicon substrate 1 to output an image. The liquid crystal display having the configuration has an LVDS receiver 20 mounted on an I/O section 15 (data receiving circuit section) in the silicon substrate 1, and receives the digital video signal in a form of a serial signal by using LVDS transmission.

The above type of the liquid crystal display inhibits the number of PADs on a silicon substrate 1 from increasing, can transmit a data without being affected by disturbance noise even when a source voltage of a logic system for processing a digital video signal is lowered, reduces an influence of the radiated noise, and can obtain an output image of high quality.

In addition, it is difficult for a general light transmitting type of a liquid crystal display to show a satisfactory performance by mounting a highly precise DAC and an LVDS receiver circuit coping with high-speed transmission on the same substrate, because a driving circuit is prepared by using a poly-silicon TFT formed on a glass substrate. In contrast to this, a reflection type of liquid crystal display (LCOS) according to the present exemplary embodiment can realize adequate transistor characteristics equivalent to those of a normal IC, because of having the driving circuit formed on a crystalline Si substrate. Accordingly, the reflection type of liquid crystal display can reduce a cost of a system, by mounting the DAC and the LVDS receiver circuit on the same substrate.

Incidentally, the above described present exemplary embodiment employs a receiver circuit of an LVDS transmission method. However, the liquid crystal display according to the present invention is not necessarily limited to that, but has only to employ a transmission method with a low amplitude and a differential mode, and may use a receiver circuit of an ECL transmission method, for instance.

A driving circuit and a pixel circuit shown in the present exemplary embodiment are formed on a silicon substrate through a CMOS process. An LVDS receiver circuit shown in the present exemplary embodiment also can be easily prepared through the CMOS process. For this reason, the liquid crystal display according to the present exemplary embodiment adopts LVDS transmission, and has the LVDS receiver circuit mounted on the substrate. On the other hand, a BiCMOS process is necessary for adopting an ECL transmission method, which increases a cost. Accordingly, it is preferable for an active matrix substrate having the driving circuit and the pixel circuit prepared through the CMOS process and a reflection type of liquid crystal display using the active matrix substrate to employ the LVDS receiver circuit which can be prepared through the same CMOS process.

### Exemplary Embodiment 2

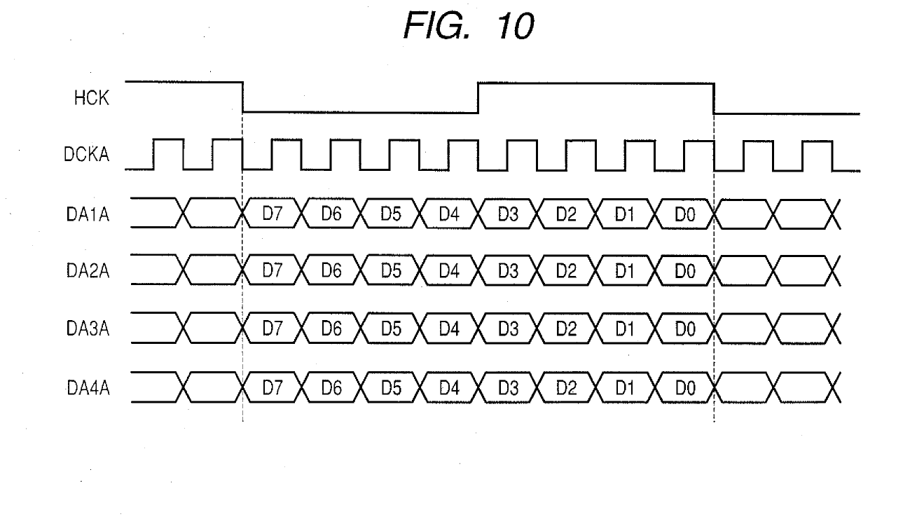

In the next place, a second exemplary embodiment of the present invention will be described with reference to FIG. 9 and FIG. 10.

In a configuration of the first exemplary embodiment, one LVDS receiver receives DAC data in 4 channels, and accordingly needs to transfer the data at a high rate. For instance, suppose a reflection type of liquid crystal display which has an effective display area of 1,280×800 pixels. Supposing that the display is equipped with a DAC circuit for 8 bits, and reverses signals for 60 frames per second at a double field speed (120 fields per second), the transfer rate exceeds 1 GHz in consideration of horizontal and vertical blanking as well. In order to realize the frequency, the display needs a process for a fine semiconductor with high withstand voltage, which increases a cost.

The present exemplary embodiment provides a reflection type of liquid crystal display in which the above point is taken into account. In the present exemplary embodiment, a component similar to that in the first exemplary embodiment is denoted by the same reference numeral, and the description is simplified or omitted.

FIG. 9 illustrates the whole configuration of a reflection type of liquid crystal display according to the present exemplary embodiment. The reflection type of liquid crystal display illustrated in FIG. 9 has LVDS receiver circuits 20 and data control circuits 21 respectively arranged for four DAC circuits 22. The other configuration is the same as in the case of a first exemplary embodiment.

In the next place, an operation of the present exemplary embodiment will be described with reference to FIG. 10.

FIG. 10 illustrates an example of a timing chart showing a relationship among video signals DA1A, DA2A, DA3A and DA4A, a video signal clock DCKA and a horizontal timing clock signal HCK, in a configuration shown in the present exemplary embodiment. In the above example, the video signals DA1A to DA4A to be input into four DAC circuits 22 are shown in 8 bits (D0 to D7) respectively.

At first, respective video signals DA1A to DA4A are received by four LVDS receiver circuits 20. These respective video signals DA1A to DA4A are each serial data. These respective serial data are synchronized with the video signal clock DCKA in the respective data control circuits 21, are output to the respective corresponding DAC circuits 22, and are converted into analog video signals in the respective DAC circuits 22. These converted analog video signals are output to respective video wires 41.

On the other hand, concurrently with the above operation, a horizontal timing clock signal HCK is input into a horizontal scanning circuit 12. The horizontal timing clock signal HCK includes such clock signals as serial data for one channel, namely, 8 bits (8 bits multiplied by 1 channel) of a video signal clock DCKA correspond to one period. Accordingly, each analog video signal in four video wires 41 is simultaneously sent to each signal wire 42, when each transfer switch 23 is turned on by output from a horizontal scanning circuit 12 based on the HCK. Thereby, in a pixel unit 11, the respective analog video signals are simultaneously written in the corresponding four pixels 31 through each signal wire 42. Afterwards, the circuit in the pixel unit 11 operates in the same way as described above.

Accordingly, a liquid crystal display according to the present exemplary embodiment has LVDS receiver circuits 20 as a pair to respective DAC circuits 22 mounted on the same silicon substrate 1, and make the respective LVDS receiver circuits 20 individually receive digital signals to be input into the respective DAC circuits 22 as the respective serial signals. Accordingly, the liquid crystal display according to the present exemplary embodiment can further reduce a data transfer rate, in addition to having the same effect as in a first exemplary embodiment.

### Exemplary Embodiment 3

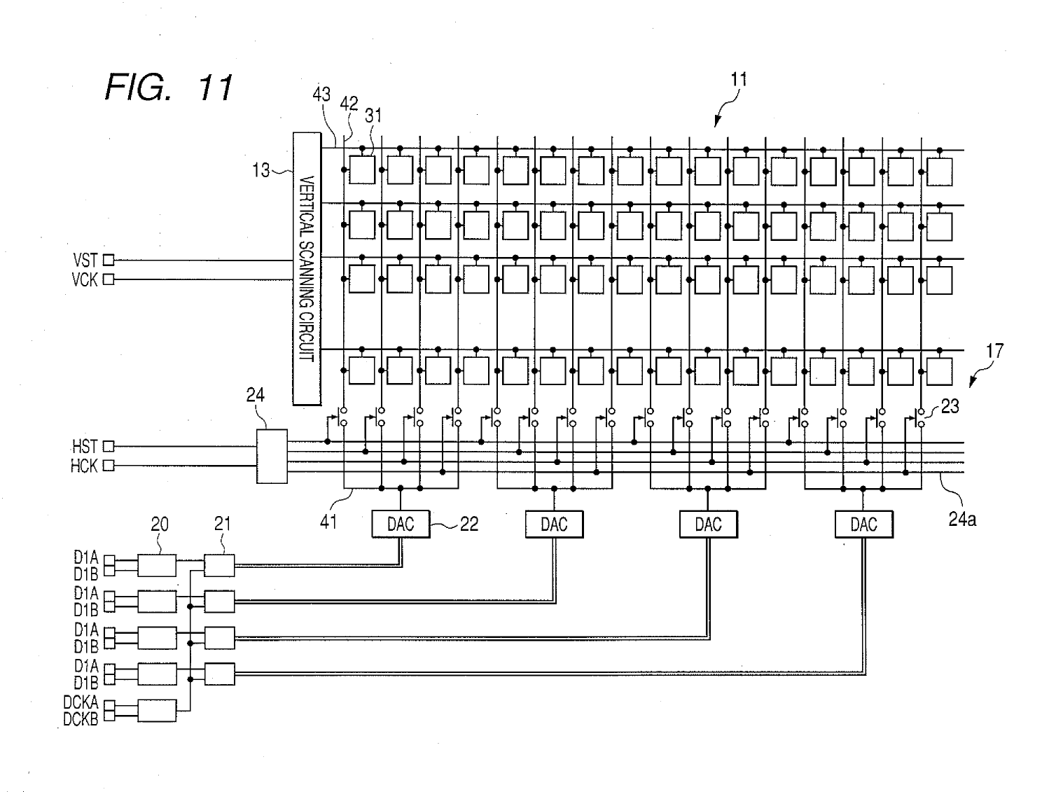

In the next place, a third exemplary embodiment of the present invention will be described with reference to FIG. 11.

In a configuration of the second exemplary embodiment, all video wires 41 are arranged in a horizontal direction in an effective pixel region, and accordingly cause large parasitic capacitance which consumes a considerable amount of an electric power. Specifically, an amplitude of voltage necessary for driving a liquid crystal is 10 V or more; the high voltage consumes a considerable amount of an electric power when the parasitic capacitance of the video wire 41 is charged and discharged, and heats a substrate; and the generated heat affects orientation characteristics of the liquid crystal and hinders the display from exhibiting an adequate image.

The present exemplary embodiment provides a reflection type of liquid crystal display in which the above point is taken into account. In the present exemplary embodiment, a component similar to that in first and second exemplary embodiments is denoted by the same reference numeral, and the description is simplified or omitted.

FIG. 11 illustrates the whole configuration of a reflection type of liquid crystal display according to the present exemplary embodiment. The reflection type of liquid crystal display shown in FIG. 9 has a transfer switch (SW) control circuit 24, in place of a horizontal scanning circuit 12 of a second exemplary embodiment. The transfer SW control circuit 24 receives a horizontal timing clock signal HCK and a horizontal timing start signal HST which are supplied from a control IC of an external driving circuit board. An output of the transfer SW control circuit 24 is connected to a gate of each transfer switch 23 through four SW control wires 24a. The control signal output from the transfer SW control circuit 24 to the four SW control wires 12a can turn on/off any one of the four transfer switches 23 connected to the signal wires 42 of four pixels.

A liquid crystal display of the present exemplary embodiment has all of four SW control wires 24a arranged in a whole horizontal direction of an effective pixel region, and has the four video wires 41 arranged only in between a DAC circuit 22 and each transfer switch 23. The other configuration is the same as in the case of a first exemplary embodiment.

In the next place, an operation of the present exemplary embodiment will be described with reference to the above described FIG. 10.

At first, respective video signals DA1A to DA4A are received by four LVDS receiver circuits 20. These respective video signals DA1A to DA4A are each serial data. These respective serial data are synchronized with the video signal clock DCKA in the respective data control circuits 21, are output to the respective corresponding DAC circuits 22, and are converted into analog video signals in the respective DAC circuits 22. These converted analog video signals are output to respective video wires 41.

On the other hand, concurrently with the above operation, a horizontal timing clock signal HCK is input into a transfer SW circuit 24. The horizontal timing clock signal HCK includes such clock signals as serial data for one channel, namely, 8 bits (8 bits multiplied by 1 channel) of a video signal clock DCKA correspond to one period. Accordingly, each analog video signal in four video wires 41 is simultaneously sent to each signal wire 42, when each transfer switch 23 is turned on by output from the transfer SW circuit 24 based on the HCK. Thereby, in a pixel unit 11, the respective analog video signals are simultaneously written in the corresponding four pixels 31 through each signal wire 42. Afterwards, the circuit in the pixel unit 11 operates in the same way as described above.

Accordingly, a liquid crystal display according to the present exemplary embodiment has LVDS receiver circuits 20 as a pair to respective DAC circuits 22 mounted on the same silicon substrate 1, and make the respective LVDS receiver circuits 20 individually receive digital signals to be input into the respective DAC circuits 22 as the respective serial signals. In addition to this, the liquid crystal display has the four video wires 41 arranged only in between a DAC circuit 22 and each transfer switch 23. Accordingly, the liquid crystal display can a parasitic capacitance of the video wire 41 and can further reduce power consumption, in addition to having the same effect as in first and second exemplary embodiments.

A liquid crystal display in the present exemplary embodiment can arrange each DAC circuits 22 on two sides which face to each other across a pixel unit 11 of a silicon substrate 1, and can further have a pair of LVDS receiver circuits 20 mounted on the same silicon substrate 1. As a result of this, the liquid crystal display can prevent heat generated in each DAC circuit 22 from propagating to the pixel unit 11 from one side in an unbalanced manner, and an influence of the heat to the pixel unit 11 from being unbalanced.

### Exemplary Embodiment 4

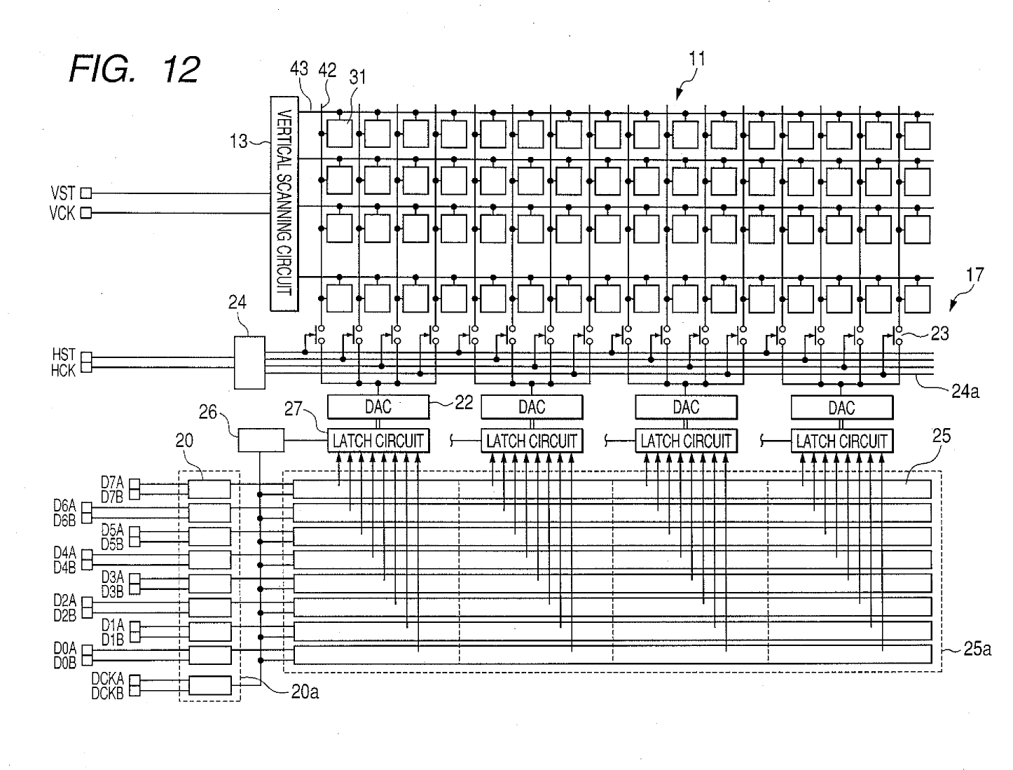

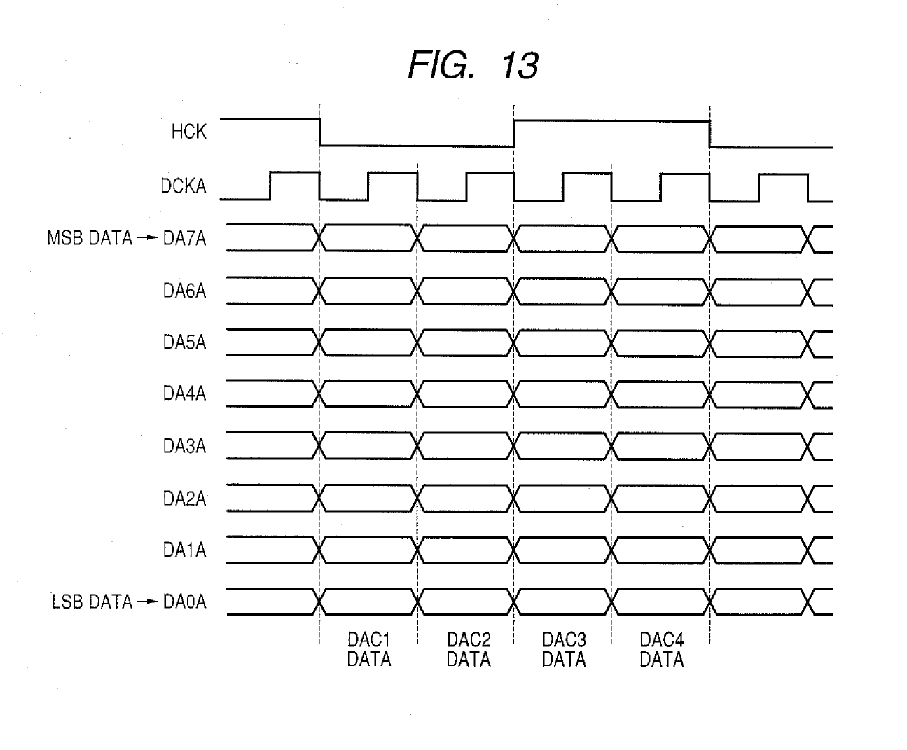

In the next place, a fourth exemplary embodiment of the present invention will be described with reference to FIG. 12 and FIG. 13.

In a configuration of a third exemplary embodiment, each DAC circuit 22 receives a data as one serial signal. In contrast to this, in the configuration of the present exemplary embodiment, each DAC circuit 22 receives the data as a serial video signal in a unit of bit.

FIG. 12 illustrates the whole configuration of a reflection type of liquid crystal display according to the present exemplary embodiment. In the present exemplary embodiment, a component similar to that in first to third exemplary embodiments is denoted by the same reference numeral, and the description is simplified or omitted.

A reflection type of liquid crystal display illustrated in FIG. 12 transmits a digital video signal to each DAC circuit 22 as a serial video signal in a unit of bit. In other words, the serial data is composed by every unit of the bit of the video signal to be input into each DAC circuit 22. For instance, the liquid crystal display transmits the video signal by packing only MSB data (or only LSB data) for each DAC circuit 22 to form the serial data. This method needs PADs of the number corresponding to bits composing the video data, but can further decrease a data transfer rate.

Reference characters D0A and D0B to D7A and D7B in the figure denote a plurality of serial data allocated in correspondence to bit positions of digital signals of 8 bits to be input into respective DAC circuits 22. In the respective serial data, serial data D7A and D7B denote MSB (Most Significant Bit) data which correspond to the most significant bits in the digital signals of 8 bits, and serial data D0A and D0B denote the LSB (Least Significant Bit) data which correspond to the least significant bits of them. Serial data D6A and D6B to D1A and D1B denote the data which correspond to the respective bits between the MSB and the LSB.

The liquid crystal display in the present exemplary embodiment has eight LVDS receiver circuits 20 for a video signal arranged as a group of LVDS receivers 20a, in order to transmit every bit to each DAC circuit 22 as a unit of a serial signal. An output of each LVDS receiver circuit 20 is connected to each 4-bit shift register 25a of a group 25a of the 4-bit shift registers 25. Respective outputs from the 4-bit shift registers 25 are connected to the respective DAC circuits 22 through the latch circuits 27 respectively.

The latch circuit 27 latches each output from the 4-bit shift register 25 on the basis of a control signal (latch timing) sent from a latch control circuit 26, and outputs the data to each DAC circuit 22. In the figure, the control signal to be input into the latch circuit 27 includes output signals based on a video signal clock DCKA and DCKB sent from the latch control circuit 26, but the configuration is not limited to this. The signal may be input from the outside similarly to the case of DCKA and DCKB. The other configuration is the same as in the case of a third exemplary embodiment.

In the next place, an operation of the present exemplary embodiment will be described with reference to FIG. 13.

FIG. 13 illustrates an example of a timing chart showing a relationship among video signals DA7A to DA0A, a video signal clock DCKA and a horizontal timing clock signal HCK, in a configuration shown in the present exemplary embodiment. In the above example, the video signal to be input into a DAC circuit 22 is shown in 8 bits.

At first, eight video signals DA7A to DA0A are received by LVDS receiver circuits 20. These respective video signals DA7A to DA0A correspond to serial data in each bit unit for the 8-bit digital video signals to be input into the respective DAC circuits 22 respectively. Each 4-bit shift register 25 synchronizes each serial data with a video signal clock DCKA, and outputs the data as a 4-bit data respectively.

Each latch circuit 25 latches the output 4-bit data in response to a control signal sent from a latch control circuit 26, and outputs the data to each DAC22, as 8-bit data, namely, digital video signals of 4 channels (data for DAC1 to DAC4) respectively. Each DAC22 converts the output 8-bit digital video signal into an analog video signal, and outputs the signal to each video wire 41.

On the other hand, concurrently with the above operation, a horizontal timing clock signal HCK is input into a transfer SW circuit 24. The horizontal timing clock signal HCK includes such clock signals as serial data for 4 channels allocated to each bit of DAC circuits 22, namely, 4 bits (1 bit multiplied by 4 channels) of a video signal clock DCKA correspond to one period. Accordingly, respective analog video signals in four video wires 41 are simultaneously sent to corresponding four signal wires 42, when each transfer switch 23 is turned on by output from the transfer SW circuit 24 based on the HCK. Thereby, in a pixel unit 11, the respective analog video signals are simultaneously written in the corresponding four pixels 31 through each signal wire 42. Afterwards, the circuit in the pixel unit 11 operates in the same way as described above.

Accordingly, the liquid crystal display according to the present exemplary embodiment transmits the video signal through converting digital signals of respective bits to be input into respective DAC circuits 22, into a plurality of serial signals allocated in correspondence with positions of the bits. Accordingly, the liquid crystal display needs PADs of the number corresponding to bits composing the video data, but can further decrease a data transfer rate.

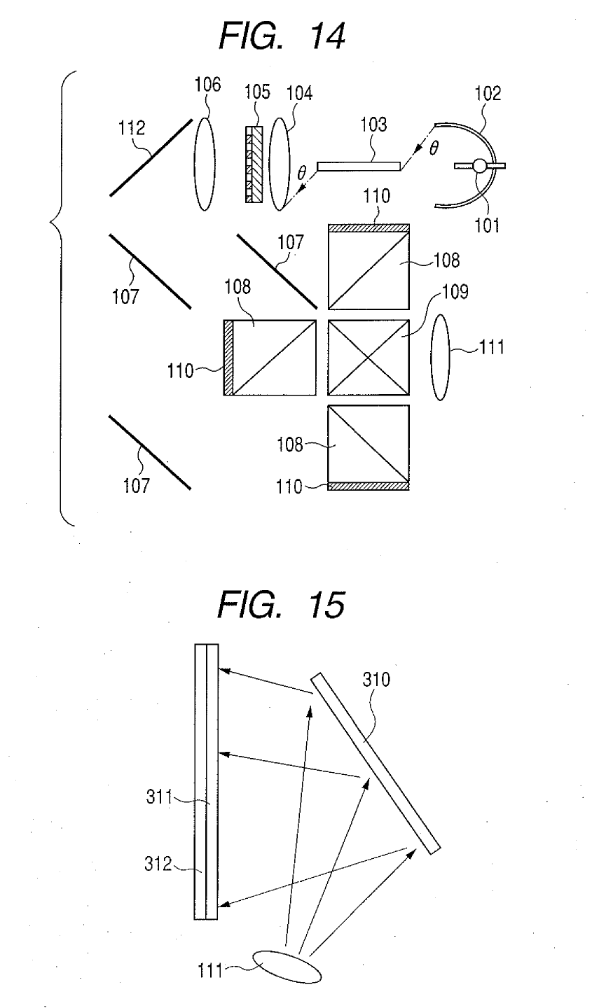

In the next place, a liquid-crystal projector of a projection type liquid crystal display apparatus will be described with reference to FIG. 14, which employs a reflection type of liquid crystal display in the above described respective exemplary embodiments.

FIG. 14 is a schematic view showing an example of an optical system for a liquid crystal projector, in a liquid-crystal projector according to the present exemplary embodiment. Reference numeral 101 denotes a lamp, reference numeral 102 denotes a reflector, reference numeral 103 denotes a rod integrator, reference numeral 104 denotes a collimator lens, reference numeral 105 denotes a polarized beam splitter and a polarized light converter with a A/2 plate, reference numeral 106 denotes a relay lens, reference numeral 107 denotes a dichroic mirror, reference numeral 108 denotes a polarized beam splitter, reference numeral 109 denotes a cross prism, reference numeral 110 denotes the reflection type of liquid crystal display according to the present invention, reference numeral 111 denotes a projection lens, and reference numeral 112 denotes a total reflection mirror.

In the configuration, a lamp 101 emits a luminous flux, and a reflector 102 reflects the emitted luminous flux to condense it to an inlet of a rod integrator 103. The reflector 102 is an oval reflector, and has focal points in a light-emitting part of the lamp 101 and the inlet of the rod integrator 103. The light flux incident on the rod integrator 103 is not reflected or repeatedly reflected once or more times in the rod integrator 103 to form a second light source image at the outlet of the rod integrator 103. There is a method of using a fly-eye lens as a method for forming a second light source, but the description will be omitted here.

A collimator lens 104 passes a light flux emitted from a second light source therethrough to convert it into an approximately parallel light, and projects it to a polarized beam splitter of a polarized light converter 105. The polarized beam splitter of the polarized light converter 105 reflects a wave (P) out of the incident light. A A/2 plate passes the wave (P) through itself to convert it into a wave (S). All the light is thus converted into the wave (S) in an emitting side of the polarized light converter 105, and the wave (S) is incident on a relay lens 106. The light flux having passed through the relay lens 106 passes through a color separation system including a total reflection mirror 112, a dichroic mirror 107, a polarizer (not shown), the polarized beam splitter 108 and a cross prism 109, and is incident on each of three reflection type of liquid crystal displays 110.

In the reflection type of liquid crystal display 110, a liquid crystal shutter controls voltage of every pixel in response to an image, and a liquid crystal modulates the wave (S) to an elliptically polarized light (or linearly polarized light). A polarization beam splitter 108 passes a wave (P) component in the modulated light, a cross prism 109 synthesizes colors, and a projection lens 111A projects the color-synthesized light therethrough.

A liquid-crystal projector illustrated in FIG. 14 can be used as a liquid crystal projector for projecting image light onto a wall or a dedicated screen when being arranged in a casing. The liquid-crystal projector can be also used in a rear-projection apparatus such as a rear-projection television. Specifically, a rear-projection apparatus such as a rear-projection television can be formed as illustrated in FIG. 15, by arranging the above described liquid-crystal projector (of which only the projection lens is illustrated) together with a reflecting mirror 310, a Fresnel lens 311 which works as a screen and a lenticular lens 312, in a casing.

As is illustrated in FIG. 15, a liquid-crystal projector emits light from a projection lens 111, a reflecting mirror 310 reflects the light and projects it onto a back plane of a screen (though the liquid-crystal projector may project the light without making the reflecting mirror reflect the light), a Fresnel lens 311 converts the light into parallel light, and a lenticular lens 312 spreads the parallel light in a wide angle. Accordingly, the above described liquid-crystal projector can be used for both of a front projection type (type of projecting image light onto wall or dedicated screen) and a rear-projection type (type of projecting image light onto back plane of screen and looking at transmitted beam through screen).

The present invention can be used in a liquid crystal display, in particular, a liquid crystal display having an active matrix substrate formed by using a single-crystal semiconductor substrate. The present invention also can be used in a reflection type of liquid crystal display and a projection type liquid crystal display apparatus using it, and can be used, in particular, in a reflection type of liquid crystal display using a material of a vertical alignment type liquid crystal including molecules having a negative dielectric anisotropy as the material of the liquid crystal, and a projection type liquid crystal display apparatus using it. The present invention also can be used for an active matrix substrate having a pixel electrode at an intersecting point of a plurality of scanning lines with a plurality of signal lines; a liquid crystal device for displaying an image and a character with the use of the active matrix substrate and the liquid crystal; and a display device using it. The present invention can be used particularly in an active matrix substrate characterized by a unit for supplying a video signal to a vertical signal wire out of a horizontal scanning circuit and a vertical scanning circuit for driving a liquid crystal; a liquid crystal device using it; and a display device using the liquid crystal device.

The present invention can be used in a liquid crystal display, a liquid-crystal projector and a rear-projection apparatus, which display an image and a character with the use of a liquid crystal; and particularly a liquid crystal display apparatus, a liquid-crystal projector, a front projection apparatus and a rear-projection apparatus, which are a projection type.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-149893, filed May 30, 2006, which is hereby incorporated by reference herein in its entirety.

What is claimed is:

1. An active matrix substrate formed from a semiconductor substrate for inputting as a digital video signal a video signal, and for converting the digital video signal into an analog video signal in the semiconductor substrate to provide an output image, comprising:
a digital-to-analog conversion circuit for converting the input digital video signal into the analog video signal; and
a receiving circuit for receiving through differential transmission each digital video signal to be inputted into the digital-to-analog conversion circuit, wherein
the receiving circuit is mounted on the same semiconductor substrate together with the digital-to-analog conversion circuit.

2. The active matrix substrate according to claim 1, wherein the differential transmission is a low voltage differential signaling transmission and the receiving circuit is a low voltage differential signaling receiver.

3. The active matrix substrate according to claim 2, wherein the low voltage differential signaling receiver has a low voltage differential signaling receiver circuit which receives each digital video signal to be input into a plurality of the digital-to-analog conversion circuits, as one serial signal.

4. The active matrix substrate according to claim 2, wherein the low voltage differential signaling receiver has a plurality of low voltage differential signaling receiver circuits which are arranged so as to respectively pair up with a plurality of the digital-to-analog conversion circuits, and individually receive each digital video signal to be input into each of the digital-to-analog conversion circuits, as respective serial signals.

5. The active matrix substrate according to claim 2, wherein the low voltage differential signaling receiver has a plurality of the low voltage differential signaling receiver circuits which individually receive each digital video signal to be input into a plurality of the digital-to-analog conversion circuits, as a plurality of serial signals allocated to each bit of the digital-to-analog conversion circuits.

6. A reflection type of liquid crystal display comprising:
the active matrix substrate according to claim 1;
an opposite substrate arranged so as to face the active matrix substrate; and
a vertical alignment type liquid crystal layer sandwiched between the active matrix substrate and the opposite substrate.

7. A reflection type of liquid crystal display according to claim 6 further comprising: an external circuit substrate electrically connected to the active matrix substrate; and a transmission circuit which pairs up with the receiving circuit, wherein the transmission circuit is mounted on the external circuit substrate.

8. A reflection type of liquid crystal display according to claim 7, wherein the transmission circuit is a low voltage differential signaling driver.

9. A projection type liquid crystal display apparatus including: the reflection type of liquid crystal display according to claim 6.
